(19) United States
(12) Patent Application Publication
(10) Pub. No.: US 2026/0122119 A1
(43) Pub. Date: Apr. 30, 2026

(54) SYNCHRONOUS VIRTUAL CLASSROOMS USING ARTIFICIAL INTELLIGENCE TECHNIQUES

(71) Applicant: NEWBai LLC, Denver, CO (US)

(72) Inventors: Nihal Eltom, Denver, CO (US); Wesley Boyer, Denver, CO (US)

(73) Assignee: NEWBai LLC, Denver, CO (US)

(21) Appl. No.: 19/368,260

(22) Filed: Oct. 24, 2025

Related U.S. Application Data
(60) Provisional application No. 63/711,879, filed on Oct. 25, 2024.

(51) Int. Cl. H04L 65/403; G06T 13/20; G06T 13/40

(52) U.S. Cl. CPC H04L 65/403; G06T 13/205; G06T 13/40

(57) ABSTRACT

Systems, devices, and techniques are disclosed for a synchronous virtual classrooms using artificial intelligence techniques. Meeting data from a virtual meeting client connected to a virtual meeting through a virtual meeting server may be received at a virtual AI avatar. The virtual AI avatar may send the meeting data to an AI agent. Avatar action data generated by the AI agent based on a portion of the meeting data may be received at the virtual AI avatar, from the AI agent. Virtual AI avatar data may be generated based on the avatar action data. The virtual AI avatar data may include generated video data, generated audio data, text data, or data causing interactions with a virtual meeting client interface of the virtual meeting client. The virtual AI avatar data may be sent to the virtual meeting client.

### BACKGROUND

Virtual classroom environments may lack the ability to provide personalized data-driven education experiences. Any data that is gathered may not be collected, analyzed, and processed in real time. This may result in a sub-optimal education for participants in online learning using the virtual classroom environments due to less meaningful feedback to instructors, students and administrators.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for synchronous virtual classrooms using artificial intelligence techniques according to an implementation of the disclosed subject matter.

FIG. 2 shows an example arrangement suitable for synchronous virtual classrooms using artificial intelligence techniques according to an implementation of the disclosed subject matter.

FIG. 3 shows an example arrangement suitable for synchronous virtual classrooms using artificial intelligence techniques according to an implementation of the disclosed subject matter.

FIG. 4 shows an example arrangement suitable for synchronous virtual classrooms using artificial intelligence techniques according to an implementation of the disclosed subject matter.

FIG. 5 shows an example arrangement suitable for synchronous virtual classrooms using artificial intelligence techniques according to an implementation of the disclosed subject matter.

FIG. 6 shows an example procedure suitable for synchronous virtual classrooms using artificial intelligence techniques according to an implementation of the disclosed subject matter.

FIG. 7 shows an example procedure suitable for synchronous virtual classrooms using artificial intelligence techniques according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable virtual AI avatars with real-time speech lip-sync synthesis for use in virtual meeting spaces. Meeting data from a virtual meeting client connected to a virtual meeting through a virtual meeting server may be received at a virtual AI avatar. The virtual AI avatar may send the meeting data to an AI agent. Avatar action data generated by the AI agent based on a portion of the meeting data may be received at the virtual AI avatar, from the AI agent. Virtual AI avatar data may be generated based on the avatar action data. The virtual AI avatar data may include generated video data, generated audio data, text data, or data causing interactions with a virtual meeting client interface of the virtual meeting client. The virtual AI avatar data may be sent to the virtual meeting client.

AI backend agents may be used to enhance virtual meetings and virtual class sessions. Web front-ends may allow the AI backend agents to join and interact with virtual meetings through automated web browser libraries. The AI backend agents may interact with virtual meetings in virtual meeting spaces using virtual AI avatars, which may appear as participants within virtual meeting spaces in the same manner that human participants may appear in the virtual meeting spaces. The virtual AI avatars may be able to generate audio for speech, and may include real-time speech lip-sync synthesis so that the virtual AI avatar may appear to talk within the virtual meeting space when generating audio for the virtual meeting space.

The virtual AI avatars may use retrieval augmented generation (RAG) for live data from the context of the virtual meeting space. For example, if the virtual AI avatar is participating in a virtual meeting space for a classroom for a class, the virtual AI avatar may have access to classroom data including, for example, chats and transcripts with timestamps and summaries from the class.

The virtual AI avatars may use RAG for documents from the context of the virtual meeting space. The virtual AI avatars may have access to summaries for all open documents, or documents otherwise associated with context of the virtual meeting space, such as a class, and may call on the RAG system to find specific information or greater detail on the documents. Results from calls to the RAG system by the virtual AI avatar may be streamed directly out through the virtual AI avatar's standard speech paths or may be used in any other suitable manner by the virtual AI avatar. The RAG system may ingest any suitable knowledge-base, such as knowledge-base for a class, so it may be a master of customer data for the context in which the virtual AI avatar will operate.

Virtual AI avatars may actively interact with the software for video calling. For example, a virtual AI avatar may view the state of various features offered by video calling software, such as “raised hands” indications from other participants in a video call meeting and feedback and reactions from other participants in a video call. The virtual AI avatar may also use these features of the video calling software within a video call meeting, for example, sending a “raise hand” indication and sending feedback reactions, searching the internet for relevant documents and launching the documents within meeting, launching other content such as learning management system (LMS) content and class documents into virtual classrooms, launching collaborative documents hosted on services such as cloud computing services into a video call meeting, actively engaging documents during a video call meeting including reading, writing, editing documents alongside real users, and providing troubleshooting advice to users having difficulties during the video call meeting.

Virtual AI avatars may also actively interact with the other types of software, such as software used for managing a class. For example, a virtual AI avatar may view chats, send chats, view live transcripts, speak in a video call meeting, view user videos, use its own virtual AI avatar video, view “raised hand” indications, feedback, and reactions, from other users, send a “raise hand” indication, send feedback, send reactions, provide troubleshooting advice to users having difficulties during a meeting, view and understand screenshare as it changes over time, share screens, use virtual background functionality, manage, open, and monitor breakout rooms, view interactive whiteboard sessions, interact with interactive whiteboard sessions, and monitor proctor mode.

Virtual AI avatars may have their real-time performance optimized for extremely fast conversational back-and-forth. Optimizations may include, for example, predictive conversational branching, multiple models handling varying response times, for example fast models returning the first sentence of a response to a user so it is as responsive as possible, followed by slower models providing additional sentences of the response after the first sentence, using websockets and streaming in all directions to minimize latency, using websockets from the backend of the software, for example, class management software, to the virtual AI agents, from the virtual AI agent backend to the virtual AI agent front end, from the AI provider/model to the class backend, and from the AI client to the speech and avatar synthesizer.

Virtual AI avatars may be able to interact with multiple users at the same time for participating naturally in a human conversation. This may include, for example, client-side monitoring of meeting audio and mechanisms for judging when and when not to cancel the current speech action, for example, to prevent the virtual AI avatar from talking over real users unless appropriate to do so.

Virtual AI avatars may include multiple activity modes for engaging in meetings, such as video call meetings, in various roles. For example, virtual AI avatars may have a quiet mode in which a virtual AI avatar will only respond when talked to directly, a passive mode in which a virtual AI avatar will only respond when spoken to or when someone is discussing an area of expertise of the virtual AI avatar, and an active mode in which a virtual AI avatar may run a meeting, such as a video call meeting, ask for input from real users, and keep the conversation going.

Virtual AI avatars may be able to synthesize multiple AI models into a single virtual AI avatar. This may allow a virtual AI avatar to merge responses from multiple AI models into one response. AI models may call other AI models from within their run within a virtual AI avatar, for example a first AI model can call a second AI model for vision, a third AI model trained specifically for math tutoring, a fourth AI model for editing collaborative documents, or any other number of fine-tuned AI models for various use-cases.

A single AI model may be able to control and coordinate multiple virtual AI avatars in the same meeting. A virtual AI avatar may crawl customer site-maps to increase customer or domain specific knowledge of the AI models. Virtual AI avatars may include internal monologues that may be used to keep meetings on track and save thoughts between backend queries. A user interface may be able to display the thoughts of virtual AI avatars to the users. The user interface may display the thoughts of a virtual AI avatar on top of video the virtual AI avatar. The thoughts may be displayed, for example, in “thought bubble” that may be inserted into the video feed for the virtual AI avatar, allowing the thoughts of the virtual AI avatar to be read by other participants in a video call without requiring software components to be added to the video calling software.

Virtual AI avatars may decide on and respect dynamic and arbitrary conditionals when deciding whether or not to engage in conversation. The processes for virtual AI avatars may be launched quickly when requested.

Data may be collected from user actions within a virtual meeting environment, such as a synchronous virtual class. An AI may be used to transcribe speech, for example, from instructors or students in class sessions and breakout rooms. Virtual meeting chats may be collected, and hand raises indications, feedback, reactions, focus or unfocus, video on/off, audio on/off, tab launches, and breakout actions may be captured. Data may be collected, for example, from class content launched during a virtual class. Tabs may be launched in class session and web pages and documents may be captured and downloaded by backend operations. Data may also be collected from materials, such as class materials that may exist outside the virtual meeting or virtual classroom. Data from a learning management system (LMS) may sync with the backend operation and content may be parsed and saved. Ingestion of knowledge-based content. Class knowledge-base and blogs may be scraped for troubleshooting and company information. Intentional data collection may be used to collect data about student knowledge during class sessions. Quizzing or survey or polling may be automatically generated throughout a class session so that when a student learned a specific piece of information or skill may be identified, and this may then be correlated with the teaching methods. Polls generated throughout class session may be used to assess student understanding and polls generated after the class session to assess student understanding and sentiment. Real-time emotional data may be scraped from voice and video using appropriate AI models. Real-time feedback may be collected, for example, from instructors in a virtual class. Point-in-time reaction data may be collected from, for example, students. Whiteboard interaction data may be collected. Temporal data regarding how long a student was engaged with a specific tab or type of content may be collected. Data from rating systems on various things like class sessions, instructors, tabs, and activities may be collected.

A sidebar user interface (UI) may allow users to ask questions to the AI system. Questions from users may be sent to the backend operations and the results may be quickly streamed back to the user. The results may show up incrementally as if being "typed" live. The backend system may suggest "further questions" that the user may be interested in asking. The user may select the suggested “further questions” using any suitable input to automatically submit the selected question to the AI system. For example, the sidebar UI may allow users to ask questions about a class history from within the class. Class history may include, for example, transcripts/chats from this class session or previous class sessions in the current course and may also include other classes the student is currently in or has been in in the past. The sidebar UI may allow users to ask questions about class content from within a class. Class content may include, for example, tabs which are currently open in class, tabs which have been opened previously in this course, tabs which have been opened in a student's other courses or previous courses. Class content may also include LMS content scraped for the present course or supplementary documents or textbooks. All content, or content currently open, may be searched to answer a question from a user unless the user selects to ask questions about a specific document which has been shared in the class, in which case the selected document may be searched to answer the users question. The sidebar UI may allow users to ask troubleshooting questions about the software during class. A class troubleshooting knowledge-base may be scraped and the AI system may allow live troubleshooting and customer support. The AI system may enable a highlighter functionality, for example, highlighting transcripts to save them as notes and/or get the AI system to explain the highlighted sections within the context of the class. The sidebar UI may also allow for an AI grader to give live feedback on assignments and papers with a picture of the AI grader provided in the sidebar. AI Grading may be performed on several criteria, including "mastery of language", "grammar and spelling", and "how well the question was answered". The sidebar UI may also allow for the generation of study-guides.

The backend system may be vendor agnostic, may utilize AI agents, may create summaries of documents and ingest data, chunks and embeds, may filter data into collections based on criteria such as class, class session, timestamp, tab id, and embedding type, and may capture metadata which may be used to retrieve source documents and display them to the user. Embeddings may be traced back to specific students and classes to rebuild entire school histories for users or prerequisites for classes. The backend system may include a system that may ingest and process live classroom data, chunks, chats, and transcripts to allow for querying and summarizing. The system for ingesting and processing class files and documents may process and ingest any suitable file types, including, for example, as PDFs, Word docs, Text files, Strings, CSV, Excel spreadsheets, Powerpoints, Github repos, Youtube videos, Webpages, Google docs, Google sheets, Google slides, Sharepoint documents, Sharepoint spreadsheets. The backend system may also include a system to ingest and process knowledge-base documents. The backend system may segment documents into chunks using LLMs for improved embedding and retrieval.

The backend system may retrieve and process class data based on user queries. The backend system may be vendor agnostic, may utilize AI agents, and may automatically select appropriate tools to use, including, for example, factual Q&A, document summary tools, document Q&A, IT and customer support tools, document grading and evaluation tools, and study-guide creation tools. The backend system may retrieve data based on filters that use criteria such as class, class session, timestamp, tab id, embedding type, provide contextual documents as part of the response, may suggest "further questions" that could be asked. Responses may be customized to each student's learning needs and style.

The backend systems may include retrieval augmented generation using AI agents to process user questions about classroom history, for example, using chats and transcripts, retrieval augmented generation using AI agents to process user questions about class content, for example, using mechanisms for processing various file types and queries and both summary and raw embedded data, and retrieval augmented generation using AI agents to process user questions about software troubleshooting.

The backend system may use AI post-processing of class interactions. Virtual classrooms may provide data such as live chats and transcripts between users. This data may be used to gain insight into the struggles or successes users are having as they use the software. Post-processing of chat and transcript data may reveal insights both for internal support purposes and as feedback for the students, instructors, and administrators of the schools. Items that may be collected and used for reports in a data portal and other suitable locations, including both raw and aggregated, include discovery of troubleshooting or bug data from live class chats and transcripts. AI may be used to identify bugs or features that users are having issues with, and may return tagged "issues" with things like "severity", "feature of interest", "raw text content", "summary of problem", "user experiencing problem", "course where problem was experienced", "timestamp.” AI may be used to monitor sentiment data from live class chats and transcripts, including identifying user sentiment and returning tagged transcripts with tags such as, for example, "confidence", "sentiment", "raw text content", "summary of comment", "user who made comment", "course where comment was found", "timestamp", and identifying features or enhancements that users would like to have added to a software product and returning tagged transcripts with tags such as, for example, "confidence", "feature of interest", "raw text content", "summary of request", "user requesting enhancement", "course where request was found", "timestamp"

The system may provide live in-session nudges, which may be on, for example, user and class information. Nudges, or prompts, may be provided to users, for example, students based on what is happening in class, cross referenced with users’ specific educational needs and history. Nudges may state, for example, "You may want to pay attention", "Your teacher is discussing fractions, which you had trouble with on your last exam", "You might remember the Spanish American war from your American History class last semester", "You showed a lot of interest then", "You seem to be having some difficulty with this topic", "Would you like me to create a study-guide for you on it after the class is over?", and "You can find more information about this topic in chapter 5 of your class textbook". Nudges may also be provided to instructors based on what is happening in class, cross referenced with class content and with the needs and history of the students in the class. Nudges provided to instructors may say, for example, "Billy seems to be struggling with this topic, he had trouble with it last semester as well, perhaps calling on him would be helpful", "Your students seem more engaged today than yesterday. They seem to respond well to group discussions", and "Samantha is very familiar with this topic, she took an elective on it last year and was at the top of her class, perhaps if you match her with Jenny on this project, Jenny will learn more". Nudges may also offer to have the system perform classroom management tasks on behalf of the instructor, and may say, for example, "I noticed that you asked the students when they have more time for this project next week", "Would you like me to launch a quick poll to get their answers?”, "There are several students in the waiting room. Would you like me to admit them?”, and "Sammy is trying to share his screen, but screen sharing is disallowed for students, would you like me to enable it?".

The system may include a data portal for customer service. The data portal for customer service may include a timeline view for displaying errors and associated logging in-line with class actions and user activities to assist in debugging issues. A user’s timeline may be selected, for example, clicked on, to bring up a full timeline of that user's actions in the class. Error icons may be selected, for example, clicked on, to bring up logs and error messages to assist in debugging. User interface elements may display AI-identified errors through analysis of live classroom transcripts and chat, including, for example, at risk instructors, which may be a list of instructors that have had the largest number of AI-identified issues, with feature type, summary, raw text, at risk features, which may be a list of the features that have had the largest number of AI-identified issues, with feature type, summary, raw text, recent issues, which may be a list of the most recent AI identified issues, with feature type, summary, raw text, and recent errors, which may be a list of all the recent errors and their counts Health scores may be calculated using AI-identified errors, client errors, backend errors, and so on.

The system may include a data portal for administrators. The data portal for administrators may include a timeline view to display all user actions throughout the course of a virtual classroom in an interactive filterable timeline, engagement scores that may be calculated using various class-specific metrics and signals, including engagement scores per individual student, engagement scores per individual instructor, and an analysis of student engagement in classes for individual instructors and aggregated engagement scores, user-centric data and AI insights including information and analysis of instructor use of AI and their most used features, and information and analysis of student use of AI and their most used features, an administrator dashboard that may include dashboards of AI-identified instructor sentiment and issues, dashboards of AI-identified student sentiment and issues, course analytics, usage analytics, and highlights of recent successes and failures, administrator user analytics including student attendance, and AI analysis of instructor or student trends, administrator course analytics including course attendance, AI generated interactive recording highlights, and the capability to generate and view quick video summaries of class sessions, and administrator feedback analysis including analysis of instructor and student feedback.

The system may include a data portal for instructors. The data portal for instructors may include an instructor dashboard that may display enrollment analytics, attendance metrics, engagement analysis for students in class, engagement analysis for instructor themselves, a list of upcoming class sessions, and notifications about student actions in classes, instructor performance analytics including student performance metrics and analysis, instructor engagement analytic including engagement metrics, AI analysis of which instructor behaviors correspond with increased student engagement and suggestion for things to try in order to increase engagement, and analysis after the fact of these strategies and success/failure reports, an instructor student performance tracker including AI based alarms for students having trouble in the instructors’ classes, indications of which students are struggling and what the students are struggling with, whether the students have been missing classes, what the students’ AI is working with them on, notes about why the students may be having trouble, indications about whether the students seem engaged, and which topics interest the students, instructor feedback analysis including AI highlighting of topics students struggled with, things students had questions about, topics that interested students, AI analysis of student engagement on topics compared with student performance on exams and assignments about those topics, and instructor content tools including AI enhanced session planning tools, AI enhanced class content creation tools such as study guides, lesson plans, and quizzes, and AI grading and analysis of class assignments and exams.

The system may include a data portal for students. The data portal for students may include a student dashboard including attendance analytics and engagement analytics calculated using virtual class-specific datasets., student performance analytics, student study aids including AI generated study guides based on class chats/, transcripts, and performance, AI generated quizzes, and AI generated advice on how to improve or learn specific things, and student gamification and goal tracking including flexible goal setting and points generated by student interactions with AI, such as for example, when a student has expressed a desire to speak up more in class, AI tracks their words per class session, AI suggests that a student work through their anxiety in class and ask the instructor to explain fractions, then checks the transcripts the next day and gives the student points if they did it, and when the student wants to answer more of the teacher's questions in class correctly, AI tracks if they have done so.

The AI may have settings that allow for control by users that are in a meeting. Control may be restricted to certain users, for example, teachers, assistants, or verified users, or may be allowed for all users. Which content users have access to when using the AI may be controlled, for example, allowing access to all content from previous class sessions, all content from the LMS, or filtered content from the LMS, and currently open content only. Meetings and AI interactions may be summarized after the class has ended, for example, with the sending of an email with a summary, an email with all of a user’s AI interactions, an email with chats and transcripts, and an email with a study guide.

The AI, given specific guidelines and wrapping functions, may dynamically code tools and games that may be launched within interactive class sessions. Tools and games can be provided with the roster of the class and can interact with the class websockets to enable real-time interactions between users. Tools may launch within an embedded browser in the virtual meeting or classroom. For example, the AI may be instructed to launch a hang-man game with words chosen from this class session please or to create an interactive game to help the students learn about biochemistry.

AI enhanced interactive playback of class recordings may include an AI guide which takes a user through the recording from timestamp to timestamp while explaining and conversing with the user to help study a specific topic. The sidebar UI with AI teaching assistant may be used in the original class session. The AI may organize a recording into sections. The AI may lead study sessions with auto-generated quizzes, which take the user through the relevant course materials and recording highlights when they miss questions. The AI may generate highlight reels for class sessions, for courses over the semester, of instructor success and failure points, and of student success and failure points. The AI may transform asynchronous class content into synchronous classes with virtual AI avatar instructors. The AI may generate a highlight reel about individual students for parents to view.

The system may include AI proctors, which may include a proctor view, may act as moderators of breakout rooms, may track interactive whiteboard sessions and feedback to instructors including a share screen built on whiteboard that may allow individual annotations for each student, along with AI feedback on those annotations and interactive playbacks, and tracking of student assignments as they're being worked on.

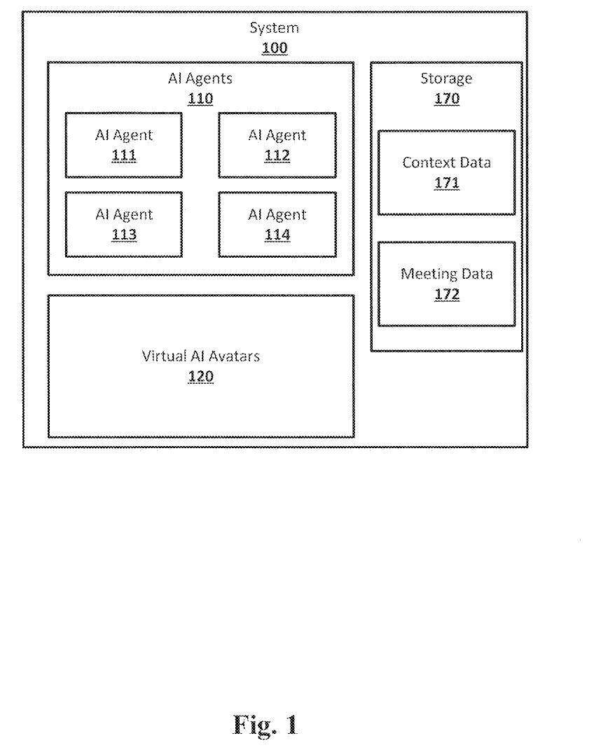

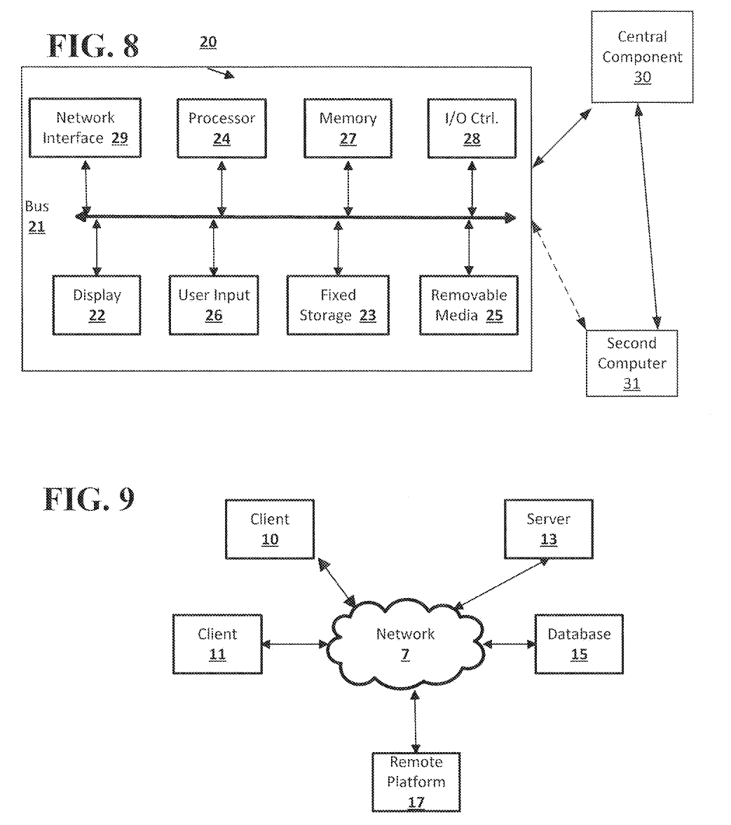

FIG. 1 shows an example system suitable for synchronous virtual classrooms using artificial intelligence techniques according to an implementation of the disclosed subject matter. A system 100 may include any suitable computing devices, such as, for example, a computer 20 as described in FIG. 8 or component thereof. The system 100 may be implemented on a laptop, a desktop, an individual server, a server cluster, a server farm, or a distributed server system, or can be implemented as a virtual computing device or system, or any suitable combination of physical and virtual systems. The system 100 can be part of a computing system and network infrastructure or can be otherwise connected to the computing system and network infrastructure, including a larger server network which can include other server systems. The system 100 may include, for example, any number of server systems which may be in communication with each other and may communicate in any suitable manner. For example, the server systems of the system 100 may be connected through any suitable network, which may be any suitable combination of LANs and WANs, including any combination of private networks and the Internet. The system 100 may be a cloud computing server system for a cloud computing service. For example, the system 100 may be, or be part of, a cloud computing sever system that may be a multi-tenanted server system.

The system 100 may include AI agents 110. The AI agents 110 may be any suitable combination of hardware and software of the system 100 for implementing AI agents, such as Ai agents 111, 112, 113, and 114. The AI agents 110 may be implemented using any suitable machine learning systems and models. The AI agents 110 may be trained for specific use-cases, such as, for example, vision, math tutoring, or editing collaborative documents, or any other suitable use-case, or may be general purpose. The AI agents 110 may be able to participate in virtual meetings, such as meetings hosted though video calling software, through the use of virtual AI avatars such as virtual AI avatars 120. The AI agents 110 may generate output for a virtual meeting, for example, text for a chat or to be output through a virtual AI avatar using real-time speech lip-sync synthesis, based on input from other users, who may be real people, in the virtual meeting. The AI agents 110 may be able to use retrieval augmented generation (RAG), for example, using context data 171 and meeting data 172, to generate output.

The system 100 may include virtual AI avatars 120. The virtual AI avatars 120 may be avatars that may appear as participants in a virtual meeting, such as a video call, and may be driven by AI agents such as the AI agents 110. The virtual AI avatars 120 may have any suitable appearance in any suitable style. For example, the virtual AI avatars 120 may be computer generated 3D imagery that appears human or human-like. The virtual AI avatars 120 may use real time speech lip-sync synthesis to generate audio output based on responses generated by AI agents, such as the AI agents 110, that are driving the virtual AI avatars 120. This may allow the virtual AI avatars 120 to participate in a virtual meeting in the same manner as human users, including talking and listening to other participants in the virtual meeting.

The system 100 may include a storage 170, which may be any suitable combination of hardware and software for storing data. The storage 170 may include any suitable combination of volatile and non-volatile storage hardware and may include components of the system 100 and hardware accessible to the system 100, for example, through wired and wireless direct or network connections. The storage 170 may store the context data 171 and the meeting data 172. The context data 171 may be context data for a virtual meeting, such as, for example, chats, transcripts, and summaries for a virtual class. The meeting data 172 may be data from within a virtual meeting, such as, for example, documents open within the virtual meeting or other documents associated with the virtual meeting. The context data 171 and the meeting data 172 may be used by, for example, the AI agents 110 for retrieval augmented generation.

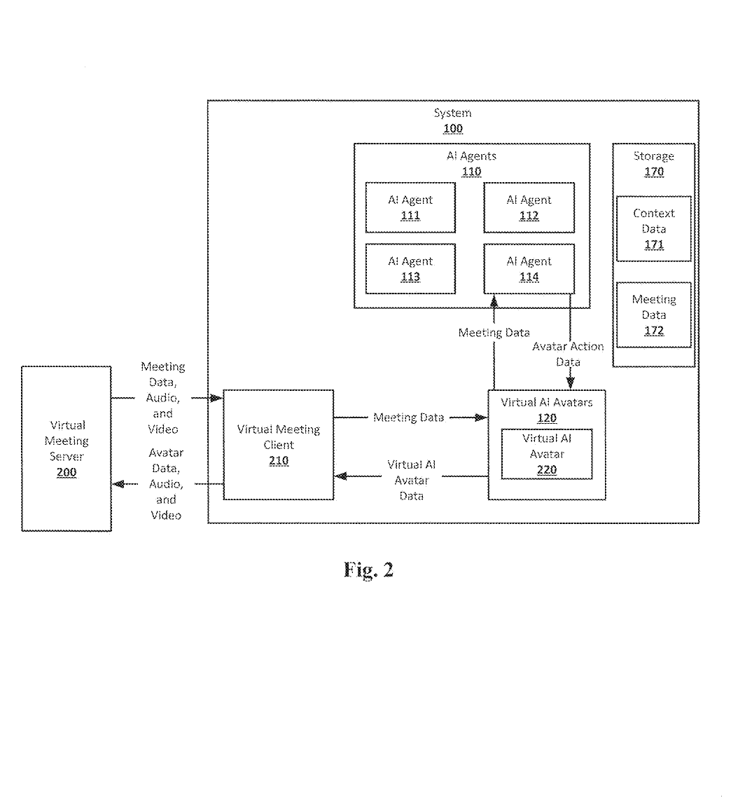

FIG. 2 shows an example arrangement suitable for synchronous virtual classrooms using artificial intelligence techniques according to an implementation of the disclosed subject matter. The virtual AI avatars 120 may participate in virtual meetings, such as video call meetings, through a virtual meeting client 210. The virtual meeting client 210 may be client software for virtual meetings that may run on the system 100 or any other suitable computing device to which the virtual AI avatars 120 may have access. The virtual meeting client 210 may connect to a virtual meeting server 200, which may host the virtual meeting, for example, video call, for any number of users connecting through any number of other virtual meeting clients. For example, the virtual meeting may be a class conducted through a video call hosted on the virtual meeting server 200 to which students may connect through the virtual meeting client running on their own computing devices. The virtual meeting server 200 may implement any suitable features for a virtual meeting, including video and audio connectivity, text chats, and hosting and distribution of documents.

Meeting data, including audio and video data from other participants in the virtual meeting, for example students in a virtual class, chat data, and other data generated by participants in the virtual meeting, may be sent from the virtual meeting server 200 to the virtual meeting client 210. A virtual AI avatar 220, one of the virtual AI avatars 220, may receive the meeting data. The meeting data may be sent as input to the AI agent 114 which may be driving the virtual AI avatar 220. The AI agent 114 may generate avatar action data based on the meeting data. The avatar action data may include any data to cause the virtual AI avatar 220 to actively interact with the virtual meeting client 210 and the virtual meeting. For example, AI agents 114 may generate text that the virtual AI avatar 220 may turn into audio that the virtual AI avatar 200 may recite in the virtual meeting, for example, using real-time speech lip-sync synthesis on the image the virtual AI avatar 220 displays in the video call. This may allow the virtual AI avatar 220 to participate in the virtual meeting through the virtual meeting client 210 in the same manner a human participant, with the actions taken by the virtual AI avatar 220, as driven by the AI agent 114, sent to the virtual meeting server 200 as audio, video, and control data, in the same manner as a human participant of the virtual meeting. The avatar action data generated by the AI agent 114 may also cause the virtual AI avatar 220 to perform actions such as typing a chat message in the virtual meeting, sharing documents in the virtual meeting, viewing the state of various features offered by video calling software, such as “raised hands” indications from other participants in a virtual meeting and feedback and reactions from other participants in a virtual meeting, using these features of the virtual meeting client 210 within a virtual meeting, for example, sending a “raise hand” indication and sending feedback reactions, searching the internet for relevant documents and launching the documents within virtual meeting, launching other content such as learning management system (LMS) content and class documents into virtual meetings, launching collaborative documents hosted on services such as cloud computing services into a virtual meeting, actively engaging documents during a virtual meeting including reading, writing, editing documents alongside real users, and providing troubleshooting advice to users having difficulties during the virtual meeting.

Meeting data from the virtual meeting server 200 sent to the virtual meeting client 210 may be continuously passed to the AI agent 114 as it arrives to allow the AI agent 114 to drive the virtual AI avatar 220 in response to the actions of the other participants in the virtual meeting as it continues, for example, allowing the AI agent 114 to generate answers to questions asked by students in a virtual class and having those answers spoken in the virtual meeting through the virtual AI avatar 220. The virtual AI avatars 220 may have their real-time performance optimized for extremely fast conversational back-and-forth. Optimizations may include, for example, predictive conversational branching, multiple models handling varying response times, for example fast models returning the first sentence of a response to a user so it is as responsive as possible, followed by slower models providing additional sentences of the response after the first sentence, using websockets and streaming in all directions to minimize latency, using websockets from the backend of the software, for example, class management software, to the AI agents 110, from the AI agents 110 backend to the AI agents 110 front end, from the AI provider/model to the class backend, and from the AI client to the speech and avatar synthesizer for the virtual AI avatar 220.

The virtual avatars 120 may be able to interact with multiple users at the same time for participating naturally in a human conversation within a virtual meeting. This may include, for example, client-side monitoring of meeting audio as received through the virtual meeting client 210 and mechanisms for judging when and when not to cancel the current speech action of the virtual AI avatar 220, for example, to prevent the virtual AI avatar 220 from talking over real users unless appropriate to do so during a virtual meeting.

The virtual AI avatars 120 may include multiple activity modes for engaging in virtual meetings, such as video call meetings, in various roles. For example, the virtual AI avatar 220 may have a quiet mode in which the virtual AI avatar 220 will only respond when talked to directly, a passive mode in which the virtual AI avatar 220 will only respond when spoken to or when someone is discussing an area of expertise of the virtual AI avatar 220, and an active mode in which the virtual AI avatar 220 may run a meeting, such as a video call meeting, ask for input from real users, and keep the conversation going.

A single one of the AI agents 110 may be able to control and coordinate multiple of the virtual AI avatars 120 in the same virtual meeting. The virtual AI avatars 120 may crawl customer site-maps to increase customer or domain specific knowledge of the AI models. The virtual AI avatars 120 may include internal monologues that may be used to keep meetings on track and save thoughts between backend queries. A user interface may be able to display the thoughts of the virtual AI avatars 120 to the users. The user interface may display the thoughts of the virtual AI avatars 120 on top of video the virtual AI avatars 120. The thoughts may be displayed, for example, in “thought bubble” that may be inserted into the video feed for the virtual AI avatars 120, allowing the thoughts of the virtual AI avatar 120 to be read by other participants in a video call without requiring software components to be added to the video calling software.

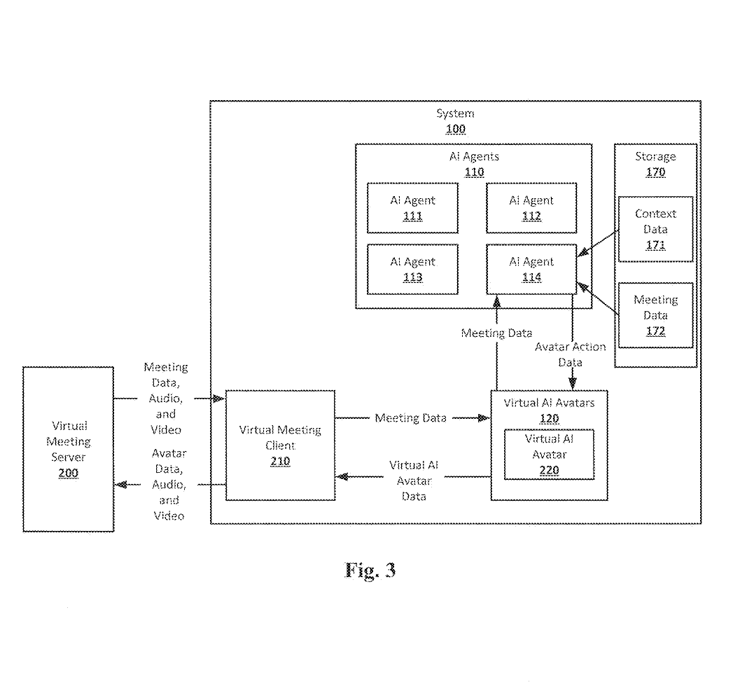

FIG. 3 shows an example arrangement suitable for synchronous virtual classrooms using artificial intelligence techniques according to an implementation of the disclosed subject matter. The virtual AI avatars 120 may use retrieval augmented generation (RAG) for live data from the context of the virtual meeting space. For example, if the virtual AI avatar 220 is participating in a virtual meeting space for a classroom for a class, the virtual AI avatar 220 may have access to classroom data including, for example, chats and transcripts with timestamps and summaries from the class, for example, stored as the context data 171. The AI agent 114 may use RAG, accessing data from the context data 171 when generating avatar action data for the virtual AI avatar 220 based on meeting data.

The virtual AI avatars 120 may use RAG for documents from the context of the virtual meeting space. For example, the virtual AI avatar 220 may have access to summaries for all open documents, or documents otherwise associated with context of the virtual meeting space, such as a class, in the meeting data 172 and may call on the RAG system to find specific information or greater detail on the documents. Results from calls to the RAG system by the virtual AI avatar 220 may be streamed directly out through the virtual AI avatar's 220 standard speech paths or may be used in any other suitable manner by the virtual AI avatar 220. The RAG system may ingest any suitable knowledge-base, such as knowledge-base for a class, so it may be a master of customer data for the context in which the virtual AI avatar 220 will operate.

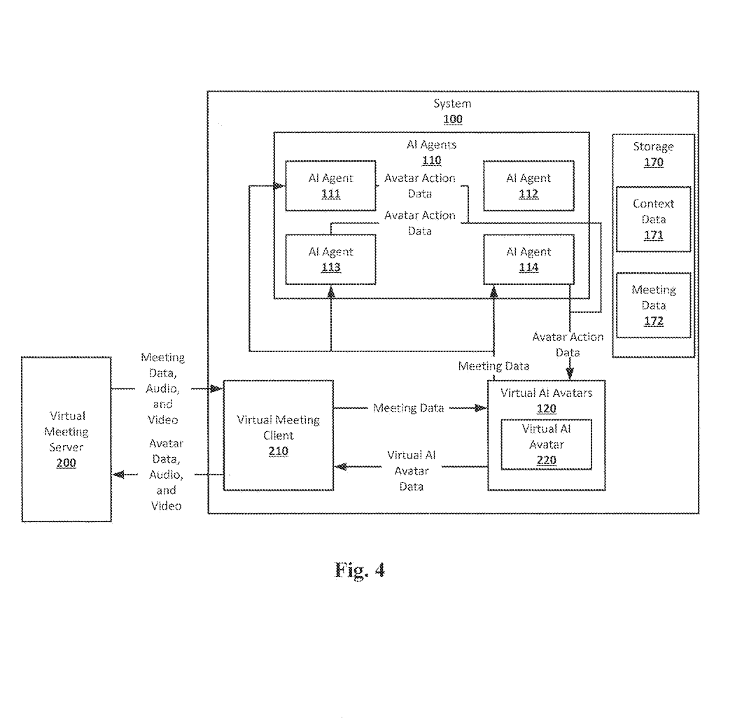

FIG. 4 shows an example arrangement suitable for synchronous virtual classrooms using artificial intelligence techniques according to an implementation of the disclosed subject matter. The virtual AI avatars 220 may be able to synthesize multiple AI models, such as the AI agents 110, into a single virtual AI avatar. For example, the virtual AI avatar 220 may merge responses from multiple of the AI agents 110, such as the AI agents 111, 113, and 114, into one response. AI agents from the AI agents 110 may also call other AI agents of the AI agents 110 from within their run within the virtual AI avatar 220. For example, the AI agent 114 may call the AI agent 113, the AI agent 111 which may be trained specifically for math tutoring, and the AI agent 112 for editing collaborative documents, or any other number of fine-tuned AI models for various use-cases.

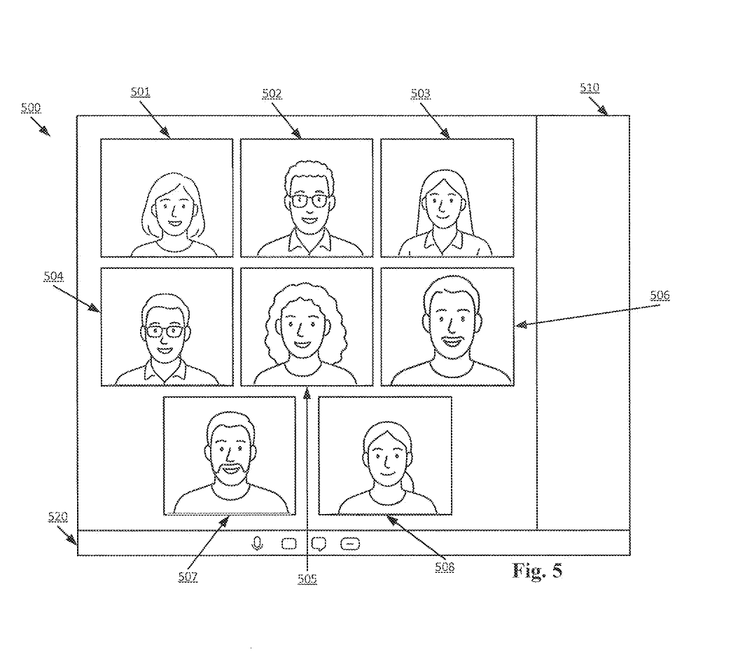

FIG. 5 shows an example arrangement suitable for synchronous virtual classrooms using artificial intelligence techniques according to an implementation of the disclosed subject matter. A virtual meeting client interface 500 may be presented to users attending a virtual meeting through, for example, copies of the virtual meeting client 210 connected to the virtual meeting server 200. The virtual meeting may be, for example, a class, and the users may be, for example, students and instructors. Users may appear in video feed windows, such as windows 501, 502, 503, 504, 505, 506, 507, and 508, which may display input from cameras on the users’ computing devices as transmitted to the virtual meeting server, and audio from users’ microphones may be played back. The virtual meeting client interface 500 may include other suitable controls and user interface elements, such as, for example, a chat window 510 and a control bar 520 that may include various controls for the virtual meeting client interface 500. A virtual AI avatar, such as the virtual AI avatar 220, that participates in a virtual meeting may send generated video data to the virtual meeting server 200 so that a visual representation of the virtual AI avatar 220 may appear in a video feed window, such as the video feed window 508, in the same manner that video appears in video feed windows for human users participating in the virtual meeting. When generated audio for the virtual AI avatar 220 is sent to the virtual meeting server 200 to be played back, the visual representation of the virtual AI avatar 220 may be animated using real-time speech lip-sync synthesis so that virtual AI avatar 220 appears other users to be talking in the virtual meeting based on the video displayed for the virtual AI avatar 200 in the video feed window 508. The generated video for the virtual AI avatar 220 may also be generated to include text that appears along with the visual representation of the virtual AI avatar 220 and indicates the thoughts of the virtual AI avatar 220. The virtual AI avatar 220, driven by, for example, the AI agent 114, may also read and type in the chat window 510 and may utilize controls from the control bar 520 to interact with the virtual meeting client interface 500, for example, to open and share documents.

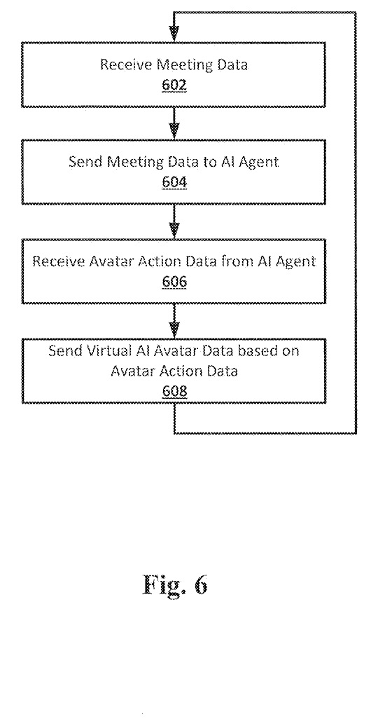

FIG. 6 shows an example procedure suitable for synchronous virtual classrooms using artificial intelligence techniques according to an implementation of the disclosed subject matter. At 602, meeting data may be received. For example, meeting data received at virtual meeting client 210 from a virtual meeting server 200 may then be received at the virtual AI avatar 220. The meeting data may include, for example, audio data, video data, chat data, and other suitable data from a virtual meeting in which the virtual AI avatar 220 is participating along with human users.

At 604, the meeting data may be sent to an AI agent. For example, the virtual AI avatar 220 may send the meeting data to suitable AI agents, such as the AI agent 114. The meeting data may be used as input to the AI agent 114. The virtual AI avatar 220 may send meeting data to multiple AI agents, and may, for example, send different portions of the meeting data to different AI agents. For example, the virtual AI avatar 220 may send video data and audio data to the AI agent 114 while sending chat data to the AI agent 113. AI agents may also send meeting data to other AI agents.

At 606, avatar action data may be received from the AI agent. For example, the virtual AI avatar 220 may receive avatar action data from AI agents to which meeting data was sent, such as the from the AI agent 114. The avatar action data may include any suitable data to cause the virtual AI avatar 220 to perform actions within the virtual meeting. The avatar action data may include, for example, text for the virtual AI avatar 220 to convert to audio and video using real time speech lip-sync synthesis so that virtual AI avatar 220 can talk in the virtual meeting, text for the virtual AI avatar 220 to enter into a chat window of the virtual meeting client 210, actions for the virtual AI avatar 220 to perform using the user interface of the virtual meeting client 220, for example, with controls of the control bar 520, and other suitable data or instructions to drive the participation of the virtual AI avatar 220 in the virtual meeting.

At 608, virtual AI avatar data may be sent based on the avatar action data. The virtual AI avatar 220 may send virtual AI avatar data to the virtual meeting client 220. The virtual AI avatar data may be any suitable data generated by the virtual AI avatar 220 based on the avatar action data received from AI agents such as the AI agent 114. The virtual AI avatar data may include, for example, generated video and audio data for playback in the virtual meeting, text entry into the chat window 510 of the virtual meeting client interface 500, and data for interaction with the controls of the virtual meeting client 210, for example, through simulating input devices, through an API of the virtual meeting client 210, or in any other suitable manner. The virtual AI avatar 220 may participate in the virtual meeting through the virtual AI avatar data sent to the virtual meeting client 210.

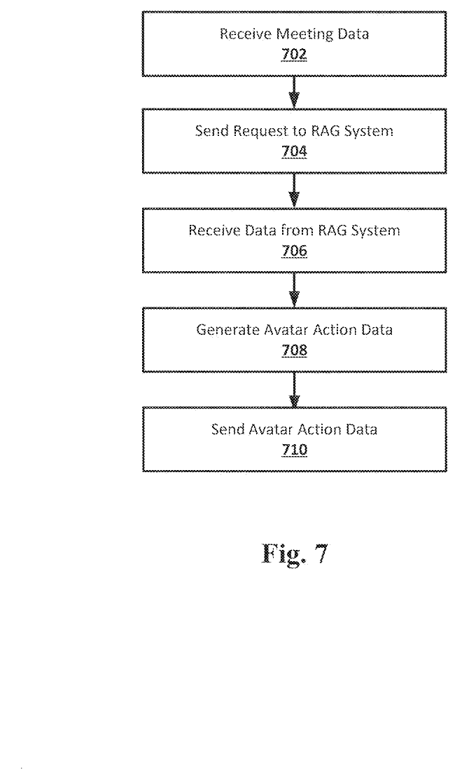

FIG. 7 shows an example procedure suitable for synchronous virtual classrooms using artificial intelligence techniques according to an implementation of the disclosed subject matter. At 702, meeting data may be received. For example, the AI agent 114 may receive meeting data from the virtual AI avatar 220. The meeting data may be from a virtual meeting in which the virtual AI avatar 220 is participating using the virtual meeting client 210.

At 704, a request may be sent to a RAG system. For example, the AI agent 114 may send a request to a RAG system to retrieve data that may be used by the AI agent 114 in generating avatar action data based on the meeting data. The request may include any suitable data from the meeting data.

At 706, data may be received from the RAG system. For example, the AI agent 114 may receive data that was retrieved by the RAG system. The RAG system may retrieve data from any suitable source, including, for example, from the context data 171 and the meeting data 172, or from external data sources. Data retrieved by the RAG system may sent back to the AI agent 114 to be used, for example, as a part of a prompt input to the AI agent 114 based on the meeting data.

At 708, avatar action data may be generated. For example, the AI agent 114 may use the meeting data and data received from the RAG system, which may be incorporated into a prompt to the AI agent 114, to generate avatar action data. The avatar action data may include any suitable data for causing the virtual AI avatar 220 to perform actions in the virtual meeting, including, for example, text to be used to generate audio, text to enter into a chat window, instructions to work with documents within the virtual meeting, and instructions to interact with controls of the virtual meeting client interface 500.

At 710, the avatar action data may be sent. For example, the AI agent 114 may send generated avatar action data to the virtual AI avatar 220. The virtual AI avatar 220 may perform actions in the virtual meeting based on the avatar action data.

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 may enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, at a virtual AI avatar, meeting data from a virtual meeting client connected to a virtual meeting through a virtual meeting server;
sending, by the virtual AI avatar, the meeting data to at least one AI agent;
receiving, at the virtual AI avatar, from the AI agent, avatar action data generated by the AI agent based on at least a portion of the meeting data;
generating virtual AI avatar data based on the avatar action data, wherein the virtual AI avatar data comprises generated video data, generated audio data, text data, or data causing interactions with a virtual meeting client interface of the virtual meeting client; and
sending the virtual AI avatar data to the virtual meeting client.

2. The computer-implemented method of claim 1, wherein the meeting data comprises audio generated by other participants in the virtual meeting, video generated by other participants in the virtual meeting.

3. The computer-implemented method of claim 1, wherein the at least one AI agent uses retrieval augmented generation (RAG) to generate the avatar action data.

4. The computer-implemented method of claim 1, wherein the virtual AI avatar or the at least one AI agent sends at least a portion of them meeting data to at least one other AI agent.

5. The computer-implemented method of claim 1, wherein the virtual AI avatar uses real-time speech lip-sync synthesis to generate the generated video based on text in the avatar action data.

6. The computer-implemented method of claim 1, further comprising launching, by the virtual AI avatar, a document from a database in the virtual meeting.

7. The computer-implemented method of claim 1, wherein the virtual meeting is for a virtual class.

8. A computer-implemented system comprising:
one or more storage devices; and
a processor that receives, with a virtual AI avatar, meeting data from a virtual meeting client connected to a virtual meeting through a virtual meeting server,
sends, with the virtual AI avatar, the meeting data to at least one AI agent,
receives, with the virtual AI avatar, from the AI agent, avatar action data generated by the AI agent based on at least a portion of the meeting data,
generates virtual AI avatar data based on the avatar action data, wherein the virtual AI avatar data comprises generated video data, generated audio data, text data, or data causing interactions with a virtual meeting client interface of the virtual meeting client, and
sends the virtual AI avatar data to the virtual meeting client.

9. The computer-implemented system of claim 8, wherein the meeting data comprises audio generated by other participants in the virtual meeting, video generated by other participants in the virtual meeting.

10. The computer-implemented system of claim 8, wherein the at least one AI agent uses retrieval augmented generation (RAG) to generate the avatar action data.

11. The computer-implemented system of claim 8, wherein the virtual AI avatar or the at least one AI agent sends at least a portion of them meeting data to at least one other AI agent.

12. The computer-implemented system of claim 8, wherein the virtual AI avatar uses real-time speech lip-sync synthesis to generate the generated video based on text in the avatar action data.

13. The computer-implemented system of claim 8, wherein the processor further launches, with the virtual AI avatar, a document from a database in the virtual meeting.

14. The computer-implemented system of claim 8, wherein the virtual meeting is for a virtual class.

15. A system comprising: one or more computers and one or more non-transitory storage devices storing instructions which are operable, when executed by the one or more computers, to cause the one or more computers to perform operations comprising:
receiving, at a virtual AI avatar, meeting data from a virtual meeting client connected to a virtual meeting through a virtual meeting server;
sending, by the virtual AI avatar, the meeting data to at least one AI agent;
receiving, at the virtual AI avatar, from the AI agent, avatar action data generated by the AI agent based on at least a portion of the meeting data;
generating virtual AI avatar data based on the avatar action data, wherein the virtual AI avatar data comprises generated video data, generated audio data, text data, or data causing interactions with a virtual meeting client interface of the virtual meeting client; and
sending the virtual AI avatar data to the virtual meeting client.

16. The system of claim 15, wherein the meeting data comprises audio generated by other participants in the virtual meeting, video generated by other participants in the virtual meeting.

17. The system of claim 15, wherein the at least one AI agent uses retrieval augmented generation (RAG) to generate the avatar action data.

18. The system of claim 15, wherein the virtual AI avatar or the at least one AI agent sends at least a portion of them meeting data to at least one other AI agent.

19. The system of claim 15, wherein the virtual AI avatar uses real-time speech lip-sync synthesis to generate the generated video based on text in the avatar action data.

20. The system of claim 15, wherein the instructions are further operable, when executed by the one or more computers, to cause the one or more computers to perform operations comprising launching, by the virtual AI avatar, a document from a database in the virtual meeting.
